(19) United States
(12) Patent Application Publication
(10) Pub. No.: US 2026/0148166 A1
(43) Pub. Date: May 28, 2026

(54) METHOD AND APPARATUS FOR REVISING A PRODUCTION PROCESS

(71) Applicant: BASF SE, Ludwigshafen am Rhein (DE)

(72) Inventors: Andreas WOLLNY, Ludwigshafen am Rhein (DE); Steffen Thomas KLOSTERHALFEN, Stockport (GB); Bastian GRUMBRECHT, Ludwigshafen am Rhein (DE); Claus TEUBER, Ludwigshafen am Rhein (DE); Ana ALBA PEREZ, Ludwigshafen am Rhein (DE); Kurt WENZL, Ludwigshafen am Rhein (DE)

(21) Appl. No.: 19/122,634

(22) PCT Filed: Oct. 18, 2023
(86) PCT No.: PCT/EP2023/079009

§ 371 Date: Apr. 18, 2025

(30) Foreign Application Priority Data
Oct. 18, 2022 (EP) 2220337.6

(51) Int. Cl. G06Q 10/0633; G06Q 30/018

(52) U.S. Cl. CPC G06Q 10/0633; G06Q 30/018

(57) ABSTRACT

A method for revising an environmental impact parameter of a production process for producing a product is provided, the method comprising receiving a product identifier for identifying the product and/or the production process for producing the product, receiving at least one feasibility process parameter, wherein the at least one feasibility process parameter comprises at least one of a target value for the environmental impact parameter for the production process of the product; and/or a quantity for at least one measure for influencing the environmental impact parameter for the production process for producing the product, assessing the production process on the basis of the at least one feasibility process parameter, providing a feasibility response, wherein the feasibility response is an indicator for the effect caused by the at least one feasibility process parameter to the production process.

### TECHNICAL FIELD

The disclosure relates to the technical field of sustainability. In particular the disclosure relates to a method for revising an environmental impact parameter of a production process for producing a product, to a computer program element with instructions, which when executed on a processing device are configured to carry out the method for revising an environmental impact parameter of a production process for producing a product, to a computer-readable medium with instructions, which when executed on a processing device are configured to carry out the method for revising an environmental impact parameter of a production process for producing a product, to a smart contract with instructions, which when executed on a processing device are configured to carry out the method for revising an environmental impact parameter of a production process for producing a product and to a reviewing apparatus for reviewing a production process of a product.

### TECHNICAL BACKGROUND

In supply chains the environmental impact of each supply chain participant is of great interest. Transparency between the participants can support a collective reduction of environmental impacts and to combat climate change.

The significance of climate protection measures is growing rapidly in the perception of the public, regulators and financial investors. Major companies have announced ambitious short-term reduction targets for environmental impact. One example are CO2 reduction targets, including emissions related to purchased raw materials as, for example, required by the Science-Based Targets Initiative (SBTI). Therefore, transparency on Product Carbon Footprints (PCF) and options to revise and/generate and in particular to reduce PCF values are increasingly demanded by customers.

End products in the chemical industry may depend on the feedstock provided as input to an industrial production network. However, the composition of an end product may be in-transparent Consequently, predicting of final PCF values and/or other sustainability parameter of an end product may be a challenging task.

### SUMMARY

Hence, there is a need for an efficient way to evaluate the effort for changing a sustainability parameter.

These and other objects, which become apparent upon reading the following description, are solved by the subject matters of the independent claims. The dependent claims refer to embodiments of the invention.

According to an aspect of the disclosure a method for controlling, monitoring, revising and/or generating an environmental impact parameter of a production process for producing a product is provided. The method may comprise receiving a product identifier for identifying the product and/or for identifying the production process and receiving at least one feasibility process parameter. The at least one feasibility process parameter comprises at least one of a target value for the environmental impact parameter for the production process of the product and/or a quantity for at least one measure for influencing the environmental impact parameter for the production process of the product.

The method further comprises assessing the production process on the basis of the at least one feasibility process parameter and providing a feasibility response, wherein the feasibility response is an indicator for the effect caused by the at least one feasibility process parameter to the production process and in particular the effect to the environmental impact parameter, e.g. a PCF value. As an example, the environmental impact parameter and/or the environmental impact of this parameter may be reduced, lowered and/or abated.

In other words, the feasibility process parameter may directly and/or indirectly indicate the desire of a user and/or an apparatus, such as a decentralized system and/or an IoT (Internet of Things) device, what kind of value and/or quantity may be revised, examined and/or amended.

Thus, this disclosure may describe a method for controlling, monitoring, revising and/or generating an environmental impact parameter of a production process for producing a product. The method may comprise receiving a product identifier for identifying the product and/or for identifying the production process and receiving at least one of a target value for the environmental impact parameter for the production process of the product and/or receiving a quantity for at least one measure for influencing the environmental impact parameter for the production process of the product.

The method further comprises assessing the production process on the basis of the at least one received target value for the environmental impact parameter for the production process of the product and/or the received quantity for the at least one measure for influencing the environmental impact parameter for the production process of the product, and providing an indicator for the effect caused by the at least one received target value for the environmental impact parameter for the production process of the product and/or the received quantity for the at least one measure to the production process and in particular the effect to the environmental impact parameter, e.g. a PCF value.

In one example a target value for the environmental impact parameter for the production process of the product may be received as a feasibility parameter. In this example a measure and/or a mix of measures may be identified which makes achieving of the target value feasible and/or possible. A ranking between the measures may be considered when identifying the measures. In one further example as an option a measure and/or mix of measures may be provided by the method which may help generating a value for the environmental impact parameter which is as close as possible to the desired target. This provision may be made in cases where the desired target value may not be achievable to the fullest.

In another example a measure and/or mix of measures may be received as feasibility parameter. In this example information may be provided as a feasibility response that indicates how the provided measure and/or mix of measures may influence the environmental impact parameter.

In a further example it may be possible to provide an amount for the effort for employing the measure and/or mix of measures in a production process for the product. This amount for the effort may be used as cost metric for a measure, as cost metric for a combination of measures and/or as cost metric for a mix of measures.

The effort may be a quantity of energy and/or time that may need to be employed. The effectiveness may be measured as an increase of a sustainability factor and/or the decrease of green house gas and/or the PCF.

According to another aspect of the disclosure a computer program element with instructions is provided, which when executed on a processing device are configured to carry out the method for revising an environmental impact parameter of a production process for producing a product.

According to a further aspect of the disclosure a computer-readable medium with instructions is provided, which when executed on a processing device are configured to carry out the method for revising an environmental impact parameter of a production process for producing a product.

According to a further aspect of the disclosure a smart contract is provided with instructions, which when executed on a processing device, such as a broker in a decentralized system, are configured to carry out the method for revising an environmental impact parameter of a production process for producing a product.

In this way a demand may be communicated to a trading and/or purchasing system for generating a product having a target value for the environmental impact parameter associated with the production process of the product and/or by using a predefined quantity for at least one measure for influencing the environmental impact parameter for the production process of the product.

For example, the use of a method for revising an environmental impact parameter of a production process for producing a product, of a smart contract and/or of an apparatus for revising an environmental impact parameter of a production process for producing a product in a computer network, such as a decentralized network, may be provided.

In yet another aspect of the present disclosure an apparatus for revising an environmental impact parameter of a production process of a product is provided. The apparatus comprises a user interface for receiving a product identifier for identifying the product and/or for identifying the production process of the process. The user interface is further configured for receiving at least one feasibility process parameter, wherein the at least one feasibility process parameter comprises at least one of a target value for the environmental impact parameter for the production process of the product and/or a quantity for at least one measure for influencing the environmental impact parameter for the production process of the product.

The reviewing apparatus also comprises a processing device for assessing the production process on the basis of the at least one feasibility process parameter.

The user interface of the reviewing apparatus is further configured for providing a feasibility response, wherein the feasibility response is an indicator for the effect caused by the at least one feasibility process parameter to the production process, wherein the effect may be discovered during the assessment of the production process on the basis of the at least one feasibility process parameter. The user interface may be an interface into a decentralized network. In this way a fully automated machine to machine environmental impact parameter adaptation may be realized.

Any disclosure, embodiment and example described herein relate to the methods, the systems, apparatuses and computer elements lined out above and below. Advantageously, the benefits provided by any of the embodiments and examples equally apply to all other embodiments and examples.

### EMBODIMENTS

The method and apparatus of the present disclosure allow for getting an overview of the effect caused by the at least one feasibility process parameter to the production process. This effect may be assessed substantially in a digital space and may prevent physical experiments prior to a choice of measures. In an example, attributes are allocated to and/or associated with a product. The attributes may classify a product as a product having a property as generated with the method and/or apparatus for revising and/or generating an environmental impact parameter.

For instance, if the environmental parameter is a PCF value and/or a water impact value the method and/or apparatus for revising and/or for generating an environmental impact parameter may be used for reducing the respective environmental impact parameter that an existing production process has and/or for generating a product production process having a predefined low environmental impact parameter. A product generated by considering the feasibility response then may be indicated as a low PCF product and/or as a low water quality impact product.

Environmental impact parameters, attributes and/or measures as provided with the method and/or apparatus for revising and/or generating an environmental impact parameter may be stored in a fact sheet, in a register, in a digital twin and/or in a material passport associated with a product produced in the production process.

Chemical production processes for producing a chemical product in a chemical production network of a chemical production plant may be available in a digital representation of the production process, e.g. a bill of material (BOM). The production process may by associated with a specific environmental impact parameter and/or with a specific environmental impact factor.

There may exist measures for reducing and/or abate the environmental impact parameter for the chemical production process. One option to find out about the effort for reaching reductions and/or abatements may be to apply the specific measure for influencing the environmental impact parameter and to check how the respective measure influences the environmental impact parameter.

However, in a chemical production plant a plurality of production processes is executed in parallel. Thus, there may exist a lot of processes that influence the environmental impact parameter. Consequently, having digital representations and/or digital twins of a production process may allow for examining a specific chemical production process. A chemical production process may be indicated by a product identifier. Such a product identifier helps identifying not only the product but also the corresponding production process. The product identifier may also make it possible to link the production processes and/or products of the physical world to a digital representation of the production processes and/or products.

The suggested method and apparatus for revising and/or generating an environmental impact parameter of a production process may help to execute the process of finding a target value. The digital execution of the method may also allow for finding measures for reaching a specific predefined target value of the environmental impact parameter. It may also be possible to test what target value may be achieved by introducing a specific measure. In this way of operating in the digital space the effort for reducing the contribution to an environmental impact may be reduced.

The digital representation of the product and/or the production process for producing the product may also allow for embedding the method and/or apparatus for revising and/or generating an environmental impact parameter of a production process for producing a product in a digital platform, such as an e-commerce platform.

In a digital architecture, to which a chemical production plant may be attached, orders may be distributed by way of digital requests. The basis for a digital architecture may form a data network for exchanging digital messages between the participants in such an architecture. The digital architecture may be used as the basis to compose the physical material flows of a product, e.g. a chemical product, through a production site. This may particular beneficial in a single input multi output production environment and/or an environment having circular processes as may be used in the chemical industry.

In an example an order for a chemical product may include a specification of an upper threshold value for an environmental impact parameter of the chemical product. This upper threshold may not be exceeded. Upon receiving such an order, the method for revising, adapting and/or generating an environmental impact parameter of a production process for producing the product may be triggered.

As a result of executing the method, the feasibility response as generated by the method may provide information whether the requested product may be delivered or not and/or what alternatives for the product may be delivered, in particular which environmental impact parameter may be provided.

In this way a fully automatic product purchase process may be set up, where digital peers negotiate about the conditions of the purchase.

In the following, embodiments of the present disclosure will be outlined by ways of examples. It is to be understood that the present disclosure is not limited to said embodiments and/or examples.

The environmental impact parameter may also be referred to as a sustainability parameter and may be a property related to an environmental impact. The property related to an environmental impact may indicate an environmental performance of one or more product(s). The property related to the environmental impact may be associated with the environmental impact of one or more product(s) at any stage during its lifecycle. The stages of the product lifecycle may include the stages of providing raw material, components and/or parts to be used for producing products, producing products, such as intermediate products or end products, using products, treating end-of-life products, recycling end-of-life products, disposing end-of-life products, reusing components from end-of-life products, or any subset of stages. The property related to environmental impact may be specified or may be derived from any activity of one or more entities participating at any stage of the lifecycle of one or more product(s).

The property related to the environmental impact may include one or more characteristic(s) that are attributable to environmental impact of a product. The property related to environmental impact may include environmental, technical or circularity characteristics(s) associated with the environmental impact of one or more product(s).

Environmental characteristic(s) may specify or quantify ecological criteria associated with the products environmental impact. Environmental characteristic(s) may be or may be derived from measures and/or measurements taken during the lifecycle of one or more product(s). Environmental characteristics may be determined at any stage of the product lifecycle and may characterize the environmental impact of the product for such stage or up to such stage.

Environmental characteristic(s) may for example include carbon footprint (PCF), greenhouse gas emissions, resource usage, air emissions, ozone depletion potential, water pollution, noise pollution or eutrophication potential, biodegradability. Environmental characteristic(s) may for example also include product characteristics related to the production of the product like bio based, vegan, halal, kosher, palm oil-free, natural or the like.

Technical characteristic(s) may specify or quantify product performance at least indirectly associated with the environmental impact. Technical characteristic(s) may be or may be derived from measurements taken during the lifecycle of one or more product(s). Technical characteristics may be determined at any stage of the product lifecycle and may characterize the product performance for such stage or up to such stage. Technical characteristic(s) may for example include product composition data, bill of materials (BOM), product specification data, product component data, product safety data, application property data, application instructions or product quality data.

Circularity characteristic(s) may specify or quantify the products life cycle characteristics associated with circular uses. Circularity characteristic(s) may be or may be derived from measurements taken during the lifecycle of one or more product(s). Circularity characteristic(s) may be or may be derived from circular data recorded in one or more prior lifecycle(s) including reuse.

Circularity characteristics may be determined at any stage of the product lifecycle and may characterize the reuse or recycling performance for such stage or up to such stage. Circularity characteristic(s) may for example include recycling data, reuse rate, recycling rate, recycling loops, reuse reused product performance, reused product quality or the like.

In an example circularity characteristic(s) may include circular feedstock(s) such a renewable raw materials and chemical recycling. Examples for renewable raw material may be ethanol (1st and 2nd generation), bio-methane, renewable cracker feedstocks, other bio (in fermentation routes) and/or feedstocks from gasification, e.g. biomass. Examples for chemical recycling may include feedstocks from gasification, e.g. waste, pyrolysis (ChemCycling) and/or chemical recycling of mono-material.

In an embodiment a processor may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor-based processor, a quantum processor, or any other type of processor configures for processing instructions. As an example, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

In an embodiment memory may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

In an embodiment, a computing node may refer to any device or system that includes at least one physical and tangible processor, and a physical and tangible memory capable of having thereon computer-executable instructions that are executed by a processor. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In an embodiment a wireless communication protocol may be used. The wireless communication protocol may comprise any known network technology such as GSM (Global System for Mobile Communications), GPRS (General Packet Radio Services), EDGE (Enhanced Data Rate for GSM Evolution), UMTS (Universal Mobile Telecommunications System)/HSPA (High Speed Packet Access), LTE (Long Term Evolution) technologies using standards like 2G, 3G, 4G or 5G, The wireless communication protocol may further comprise a wireless local area network (WLAN), e.g. Wireless Fidelity (Wi-Fi).

In an embodiment distributed computing may be implemented. Distributed computing may refer to any computing that utilizes multiple computing resources. Such use may be realized through virtualization of physical computing resources. One example of distributed computing is cloud computing. “Cloud computing” may refer to a model for enabling on-demand network access to a shared pool of configurable computing resources (e.g., networks, servers, storage, applications, and services). When distributed, cloud computing environments may be distributed internationally within an organization and/or across multiple organizations. In an embodiment, distributed computing may be realized in a federated network.

The user interface may comprise an input and/or output device which may provide interfaces to any type of wired or wireless data network. The user interface may be used to receive and/or get the product identifier and/or the at least one feasibility process parameter. The data network may provide access to distributed computing and/or cloud computing. The user interface may also allow to distribute a feasibility response to different digital destination in order to use the corresponding results.

According to another aspect of the disclosure the feasibility response comprises a quantity of at least one measure and/or a mix of measures for reaching a desired target value for the environmental impact parameter for the production process of the product. In an example a quantity may be an absolute value. In another example the quantity may be a portion, e.g. a percentage value.

Such a response may be provided when assessing the production process on the basis of the at least one feasibility process parameter finds a solution for meeting the target value.

I.e., if a target value for the environmental impact parameter for the production process of the product, e.g. a target PCF value and/or a low PCF value, is received and this target may be met by a measure and/or by a mix of measures, the measures are provided as a result, including their quantities. With this result a production process may be adjusted in order to generate the desired product as a low PCF product.

If the target value for the environmental impact parameter may not be reached and/or achieved an alternative solution in form of an alternative and/or different target value for the environmental impact parameter may be suggested by the method.

In other words, the useful combinations of a target value for the environmental impact parameter for the production process of the product and the quantities for at least one measure for influencing the environmental impact parameter for the production process of the product form and/or span a mathematical solution space which may be restricted by border conditions. The method for revising an environmental impact parameter of a production process for producing a product and/or the revising apparatus for revising a production process for producing a product may help finding a valid solution in this solution space. In order to find a valid solution, the actual production process may be considered comprising substantially all the physical impact to the environment caused by the production process. Information about the physical impact may be found in a database. An optimization algorithm may be set up for finding valid solutions in the solution space.

In another aspect of the disclosure the feasibility response comprises an effort value that is necessary for reaching the target value of the environmental impact parameter for the production process of the product.

In an example effort may express the amount of work involved in generating and/or producing a product and/or a material and/or the amount of work for a measure. In a particular example more effort is needed for generating a replacement material, e.g. a renewable or recycled feedstock. The effort may be based on “proof of work”, i.e. more work may be necessary to generate the replacement feedstock. In another example effort may refer to the availability of the product and/or material and/or the time duration and/or the resources employed to generate it. The effort may be converted to a metric such as a price, an amount of energy and/or a number of other resources in a common unit, e.g. on the basis of the International System of Units (SI), in order to make the effort comparable. In an example a normalization and/or standardization of values may take place. An example for a metric may also be a currency and/or a price. The effort may also express the work that has to be made when producing the product by a specific measure. In an example the effort may express the difference of extra work to be made by producing the product according to a measure compared to a different way of producing the product. In another example the effort may also express the cost for employing different materials that may have to be purchased.

The effort value may be used as criteria for choosing and/or assessing a specific measure.

Bringing the effort to a common unit may allow using the effort in an optimization formula.

In an example the feasibility response comprises an adapted target value for the environmental impact parameter for the production process of the product.

If assessing the production process on the basis of the at least one feasibility process parameter shows that the desired target value for the environmental impact parameter for the production process of the product may not be reachable, e.g. the desired PCF value is too low and cannot be met with the available measures, an alternative target value for the environmental impact parameter may be provided by the method even it does not completely fulfill the requirement completely.

According to a further aspect of the present invention a ranking of the at least one measure for influencing the environmental impact parameter is provided in order to show and/or to set a preference for one of the at least one measure for influencing the environmental impact parameter for the production process for producing the product.

In cases where at least two measures for influencing the environmental impact parameter are presented and/or discovered by the method and offered to a user, a user may indicate a preference for one of the at least two measures.

In an example the preference for a measure may be indicated before executing the method, e.g. by setting up a user profile which stores the preferences of a user, in particular the preferences of a user for a specific measure.

According to yet another aspect of the disclosure the presented at least one measure for influencing the environmental impact parameter depends on the received product identifier.

In other words, different products may have different environmental impact parameters for the production process of the product. For example, products that may not involve incineration may not depend on measures that generate a low PCF value while products that may not generate wastewater do not benefit from measures that target to reducing wastewater.

Consequently, in order to reduce the number of possible measures and not confuse a user with too much information not all measures are offered but only the significant measures are offered that may promise the most benefit for the specific product and/or the specific production process. A user may get a clear picture about the relevant most promising measures.

According to yet another aspect of the present disclosure assessing the production process on the basis of the at least one feasibility process parameter deploys an environmental attribute calculation schema, e.g. a mass balance calculation schema.

For finding measures that support reaching a target value for the environmental impact parameter for the production process of the product quantities for at least one measure for influencing the environmental impact parameter for the production process of the product may need to be found. Starting from an environmental impact parameter of a production process for producing of a product a change in the target value for the environmental impact parameter may be caused by replacing a certain quantity of a process parameter of the production process by a quantity of a measure. For example, in order to reduce the PCF value of a product a process parameter like a quantity of a fossil feedstock may be replaced by a corresponding quantity of a renewable and/or recycled feedstock.

In order to compare recycled, renewable, and/or bio-based content of one or more input material(s) used in a chemical production network balancing units may be used. The balancing units may be based on the heating value of a material.

Calculating with common units, e.g. units which are defined by the International System of Units (SI), may make results comparable. Examples for common units are mass, weight, hydrogen atoms, carbon atoms, methane equivalents. These parameters may be measured in kg, CO2 equivalents per heating unit (kg CO₂ kg per heating unit, kg methane equivalent) where a heating unit is a common unit for heat generated by burning. A heating unit may be referenced to 50 MJ, wherein 50 MJ is approximately the lower heating value of natural gas. This common unit may make the energy content of renewable feedstocks, chemically recycled feedstocks and/or fossil feedstock comparable. A mass balance calculation schema may be based on heating units. Based on the balancing schema different materials may be exchanged and/or replaced.

In another example, a heating unit may be seen as a balancing unit. An environmental impact parameter and/or an environmental attribute may be converted to one or more balancing unit(s). The one or more balancing unit(s) may be allocated to the at least one balancing account associated with the respective environmental attribute.

At least one environmental attribute may be assigned to the product, e.g. a chemical product. Assigning an environmental attribute may include converting the one or more balancing(s) to one or more environmental attributes(s). The one or more balancing unit(s) may be deallocated from at least one balancing account associated with the respective environmental attribute.

The mass, weight, hydrogen atoms, carbon atoms, methane equivalents or any other are suitable measure for quantifying the environmental impact of the environmental attribute. By using balancing unit(s) it can be ensured that environmental attributes of input materials are only used once for assignment to chemical products. This way double counting on input or output is avoided and the positive environmental impact can be reliably assigned to chemical products.

Allocating and/or deallocating environmental attribute(s) based on mass may be referred to as a mass balance calculation schema.

In an example process parameter for every produced product and/or a related production process may be stored in a database. The process parameters include input material and/or raw material which form the basis for the product. Such process parameter may be retrieved from the database, e.g. from a BOM and or a recipe stored in the database, and then individual input material, raw material may be replaced by the type and quantity of replacement products according to the assessed measure.

Similar as for the effort, bringing amounts and quantities to a common unit may allow using the amounts and quantities in an optimization formula.

Another aspect of the present disclosure provides for assessing the production process on the basis of the at least one feasibility process parameter by deploying an optimization model.

An optimization model may help finding a valid combination of a target value for the environmental impact parameter for the production process of the product and a quantity for at least one measure for influencing the environmental impact parameter for the production process of the product.

This detected combination may be a starting point for variations of target values for the environmental impact parameter for the production process of the product and quantities for at least one measure for influencing the environmental impact parameter for the production process of the product.

Further support in finding solutions for desired target values and/or necessary measures and respective quantities may be provided by generating a graphical representation of possible variations. Such a graphical diagram may indicate shares of renewable and/or recyclable feedstock as well as limits for exchanging fossil with renewable and/or recycled feedstock.

In another aspect of the disclosure the environmental impact parameter for the production process of a product is an environmental impact parameter for the production process of a product selected from the group of environmental impact parameter. The group of environmental impact parameter consists of a product carbon footprint (PCF) value, a wastewater value, an emission value, a heating value and a waste incineration value.

Different parameters that may be desired to be reduced can be examined with the disclosed method and/or apparatus.

According to another aspect of the present disclosure, the at least one measure for influencing the environmental impact parameter is a measure selected from the group of measures, consisting of employing sustainable material, employing green energy, employing a circular feedstock, employing a renewable feedstock, employing a recycled feedstock, employing end of life tires, employing mixed waste plastic, employing bio-naphtha and employing bio-methane.

Green electricity and/or green energy may refer to any form of electricity, heat or steam generated from renewable resources such as wind, tides, geothermic and/or solar.

The group of measures may have an impact on and/or may be correlated with the target value for the environmental impact parameter for the production process for producing the product. Using the disclosed method and/or apparatus may help to identify the actual impact to the present situation under examination by substantially simulating and/or calculating the production process and/or by using data for the production process of the relevant product.

In yet another aspect according to the disclosure, parameters of the production process are substantially derived from a database.

In this way the production process may not permanently be repeated in order to have reference values for the production process. The parameters of the production process may be stored in a database in form of a matrix and/or BOM and/or in a recipe. In an example the parameters for the production process to be revised may comprise natural gas (NG) and Naphtha (Na).

In other words, a database may exist which is usable as a look up table for the production process parameters and may store parameters such as the input parameters for the production process of each product. The lookup table may allow for a quick data access and a fast evaluation of the impact of the quantity for at least one measure for influencing the environmental impact parameter for the production process of the product to the environmental impact parameter and vice versa.

The process parameters may comprise the quantity and/or type of an input parameter for a chemical production process in a chemical production network. The input parameters may comprise natural gas (NG) and Naphtha (Na).

According to another aspect of the disclosure. The method further comprises controlling the production process of a product in a plant and/or in a production network with the quantity for the at least one measure for influencing the environmental impact parameter for the production process of the product for influencing the environmental impact parameter.

The identified measures may be employed in the plant and/or in the production network, in order to produce the product with a corresponding environmental impact parameter. If for example a low PCF product may be desired, in the production process renewable and/or recycled feedstock is used.

According to another aspect of the disclosure the product is a chemical product produced in a chemical production network of a chemical plant.

The process is a chemical production process using a chemical reaction.

In an example the product is a chemical product.

### BRIEF DESCRIPTION OF THE DRAWINGS

In the following, the present disclosure is further described with reference to the enclosed figures. The same reference numbers in the drawings and this disclosure are intended to refer to the same or like elements, components, and/or parts.

FIG. 1a illustrates a centralized computing environment according to an exemplary embodiment of the present invention.

FIG. 1b illustrates a decentralized computing environment according to an exemplary embodiment of the present invention.

FIG. 1c illustrates a distributed computing environment according to an exemplary embodiment of the present invention.

FIG. 2 illustrates a block diagram of a revising apparatus according to an exemplary embodiment of the present invention.

FIG. 3 shows a flow chart for a method for revising an environmental impact parameter of a production process for producing of a product according to an exemplary embodiment of the present invention.

FIG. 4 shows a graphical user interface for operating a revising apparatus according to an exemplary embodiment of the present invention.

FIG. 5 shows a measure mix impact to a target value according to an exemplary embodiment of the present invention.

FIG. 6a, b show a more detailed view of the flow chart of FIG. 3 for a method for revising and/or generating an environmental impact parameter of a production process for producing a product according to an exemplary embodiment of the present invention.

### DETAILED DESCRIPTION

The following embodiments are mere examples for implementing the method, the system or application device disclosed herein and shall not be considered limiting.

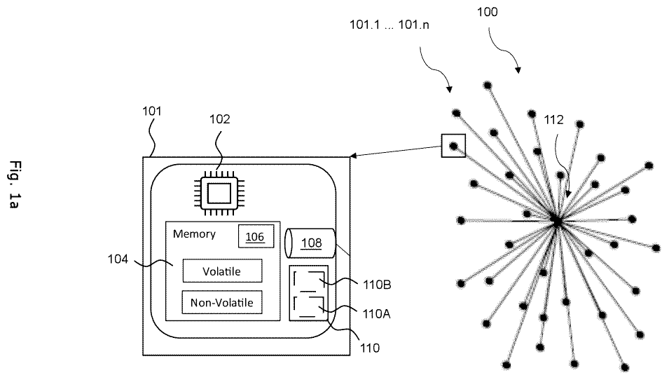

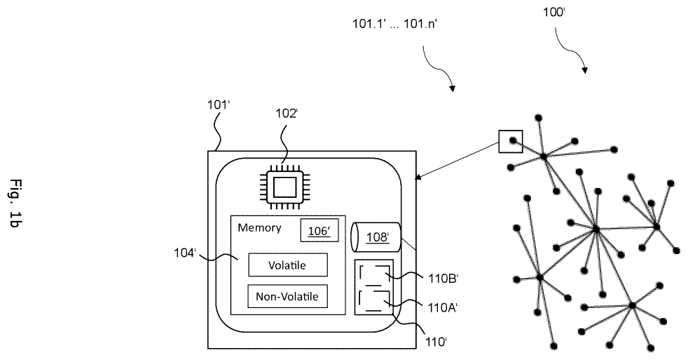

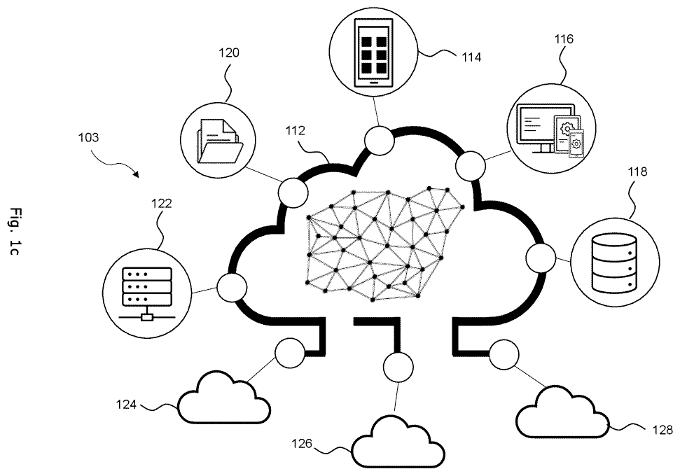

FIGS. 1a to 1c illustrate different computing environments, central, decentral and distributed. The methods, apparatuses, systems, uses, computer elements of this disclosure may be implemented in decentral or at least partially decentral computing environments. Providing, determining or processing of data may be realized by different computing nodes, which may be implemented in a centralized, a decentralized or a distributed computing environment.

FIG. 1a illustrates a centralized computing environment for a better understanding of the present invention.

In this example, the peripheral computing nodes 101, 101.1 to 101.n may be connected to one central computing system (or server) 112. In another example, the peripheral computing nodes 101, 101.1 to 101.n may be attached to the central computing node via e.g. a terminal server (not shown). The majority of functions may be carried out by or obtained from the central computing node 112. The central computing node 112 may be called remote centralized location.

One peripheral computing node 101 of the plurality of peripheral computing nodes 101.1 to 101.n has been expanded to provide an overview of the components present in the peripheral computing node. The peripheral computing node 101 may comprise the same components as described in relation to the peripheral computing node 101.n. Each computing node 101, 101.1 to 101.n may include at least one hardware processor 102 and memory 104.

The computing nodes 101, 101.1 . . . 101.n may include program code 106 which is schematically represented as a plurality of structures 106. The plurality of structures 106 may be referred to as an executable component, executable instructions, computer-executable instructions or instructions. Executable component or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 101, 101.1 . . . 101.n, whether such an executable component exists in the heap of a computing node 101, 101.1 . . . 101.n, or whether the executable component exists on computer-readable storage media. In such a case, one of ordinary skill in the art will recognize that the structure of the executable component exists on a computer-readable medium such that, when interpreted by one or more processors of a computing node 101, 101.1 . . . 101.n (e.g., by a processor thread), the computing node 101, 101.1 . . . 101n is caused to perform a function.

Such a structure may be computer-readable directly by the processors 112 (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the words component, agent, manager, service, engine, module, virtual machine or the like are used synonymous with executable component.

The processor 102 of each computing node 101, 101.1 . . . 101.n may direct the operation of each computing node 101, 101.1 . . . 101.n in response to having executed computer-executable instructions that constitute an executable component. For example, such computer-executable instructions may be embodied on one or more computer-readable media that form a computer program product. The computer-executable instructions may be stored in the memory 104 of each computing node 101, 101.1 . . . 101.n. Computer-executable instructions comprise, for example, instructions and data which, when executed at a processor 101, cause a general purpose computing node 101, 101.1 . . . 101.n, special purpose computing node 101, 101.1 . . . 101.n, or special purpose processing device to perform a certain function or group of functions. Alternatively, or in addition, the computer-executable instructions may configure the computing node 101, 101.1 . . . 101.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 101, 101.1 . . . 101.n may contain communication channels 108 that allow each computing node 101.1 . . . 101.n to communicate with the central computing node 112, for example, a network enabling the transport of electronic data between computing nodes 101, 101.1 . . . 101.n and/or modules and/or other electronic devices. When information is transferred or provided over a network or another communications connection (either hardwired, wireless, or a combination of hardwired or wireless) to a computing node 101, 101.1 . . . 101.n, the computing node 101, 101.1 . . . 101.n properly views the connection as a transmission medium. Transmission media can include a network and/or data links which can be used to carry desired program code means in the form of computer-executable instructions or data structures and which can be accessed by a general-purpose or special-purpose computing nodes 101, 101.1 . . . 101.n. Combinations of the above may also be included within the scope of computer-readable media.

The computing node(s) 101, 101.1 to 101.n may further comprise a user interface system 110 for use in interfacing with a user. The user interface system 110 may include output mechanisms 110A as well as input mechanisms 110B. The principles described herein are not limited to the precise output mechanisms 110A or input mechanisms 110B as such will depend on the nature of the device. However, output mechanisms 110A might include, for instance, displays, speakers, displays, tactile output, holograms and so forth. Examples of input mechanisms 110B might include, for instance, microphones, touchscreens, holograms, cameras, keyboards, mouse or other pointer input, sensors of any type, and so forth.

In an example a computing node 101, 101.1 to 101.n may also be controlled and/or operated via a remote terminal, e.g. via SSH (Secure Shell) and/or a remote Windows system, e.g. X-Windows. In such cases the user may be connected via a communication channel 108 to the output mechanisms 110A and/or input mechanisms 110B.

In yet another example, the output mechanisms 110A and/or input mechanisms 110B offer a standardized interface e.g. via an API (Application Programming Interface). Such an interface may be secured by any form of authentication and/or authorization schema in order to restrict the access to the API.

Any form of remote and/or local access may not be restricted to the type of network architecture. Therefore, remote access may be offered by a central computing environment, a decentralized computing environment 100 and/or by a distributed computing environment 103.

FIG. 1b illustrates a decentralized computing environment 100′ with several computing nodes 101.1′ to 101.n′ for a better understanding of the present invention.

The plurality of computing nodes 101.1′ to 101.n′ are shown as filled circles. In contrast to the centralized computing environment 100 illustrated in FIG. 1a, the computing nodes 101.1′ to 101.n′ of the decentralized computing environment are not connected to a central computing node 112 and are thus not under control of a central computing node. Instead, resources, both hardware and software, may be allocated to each individual computing node 101.1′ . . . 101.n′ (local or remote computing system) and data may be distributed among various computing nodes 101.1′ . . . 101.n′ to perform the tasks. Thus, in a decentral system environment, program modules may be located in both local and remote memory storage devices. One computing node 101′ has been expanded to provide an overview of the components present in the computing node 101′. In this example, the computing node 101′ comprises corresponding components as described in relation to FIG. 1a.

FIG. 1c illustrates a distributed computing environment 103 for a better understanding of the present invention.

In this example, the distributed cloud computing environment 103 may contain the following computing resources: mobile device(s) 114, applications 116, databases 118, data storage 120 and server(s) 122. The cloud computing environment 103 may be deployed as public cloud 124, private cloud 126 or hybrid cloud 128. A private cloud 126 may be owned by an organization and only the members of the organization with proper access can use the private cloud 126, rendering the data in the private cloud at least confidential. In contrast, data stored in a public cloud 124 may be open to anyone over the internet. The hybrid cloud 128 may be a combination of both private and public clouds 124, 126 and may allow to keep some of the data confidential while other data may be publicly available.

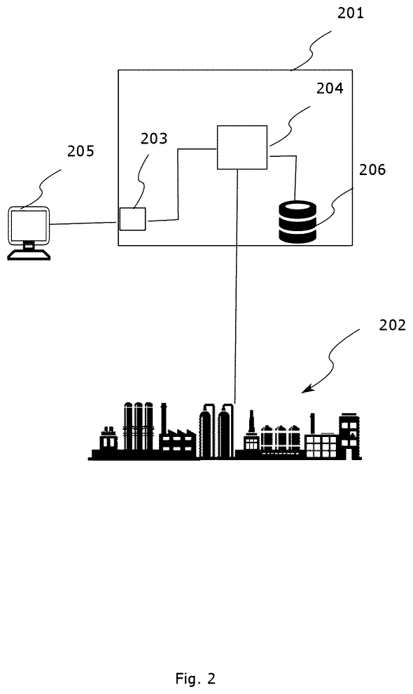

FIG. 2 illustrates a block diagram of a revising apparatus according to an exemplary embodiment of the present invention.

A revising apparatus 201 for revising and/or generating a production process 202 for producing a product. The apparatus comprises a user interface 203 and a processing device 204 which are connected to another.

The user interface 203 is adapted for receiving a product identifier for identifying the product and/or the production process for producing the product. The user interface 203 is also adapted for receiving at least one feasibility process parameter, wherein the at least one feasibility process parameter comprises at least one of a target value for the environmental impact parameter for the production process of the product; and/or a quantity for at least one measure for influencing the environmental impact parameter for the production process of the product.

The processing device 204 is configured for assessing the production process 202 on the basis of the at least one feasibility process parameter, wherein the user interface 203 is configured for providing a feasibility response. The feasibility response is an indicator for the effect caused by the at least one feasibility process parameter to the production process. In one example the assessment and/or analysis of the production process 202 is made on a digital model and/or on a digital twin of the production process. In another alternative example the assessment may be made on the physical production network of a plant.

The user interface 203 is operated by the local display device 205. In another alternative (not shown in FIG. 2) instead of a local display device a remote display device may be used. The user interface 203 may be adapted to receive a smart contract and to execute the program code and/or the method stored in such smart contract.

The database 206 stores values for the production process 202 for every product.

The revising apparatus 201 may be configured in any computer architecture. In one example the revising apparatus 201 may be designed as a standalone and/or desktop application running on single computing device such as a desktop computer and/or a portable computer.

In another example the revising apparatus 201 may be designed as a peripheral computing node 101, 101.1 to 101.n and/or as a central computing system 112.

In a further application the revising apparatus 201 may be designed as one of the several computing nodes 101.1′ to 101.n′ in a decentralized computing environment 100′.

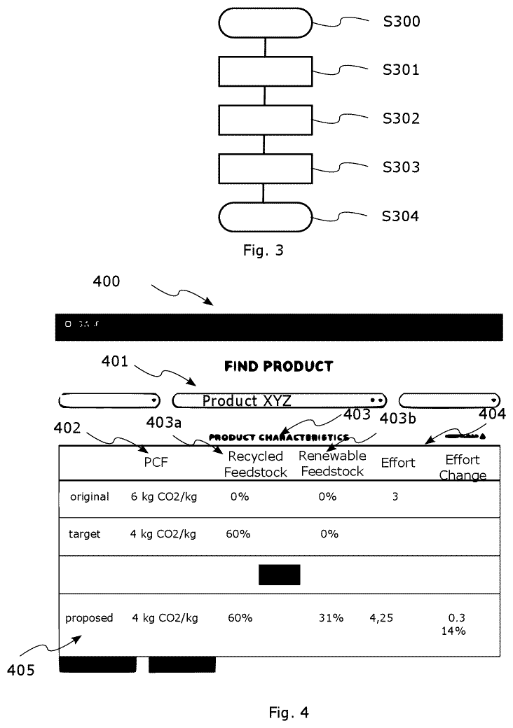

FIG. 3 shows a flow chart for a method for controlling, monitoring, revising and/or generating an environmental impact parameter of a production process for producing of a product according to an exemplary embodiment of the present invention.

The method starts in idle stage S300. In stage S301 a product identifier for identifying the product and/or the production process for producing the product and at least one feasibility process parameter is received, e.g. via user interface 203. The user interface 203 can comprise a graphical user interface (GUI) which is remotely and/or locally displayed in order to enable a user to enter any input or to show any results. In another example the user interface may also comprise an API such as a REST API.

The at least one feasibility process parameter comprises at least one of a target value for the environmental impact parameter for the production process 202 of the product and/or a quantity for at least one measure for influencing the environmental impact parameter for the production process for producing the product.

In stage S302 the production process 202 is assessed on the basis of the at least one feasibility process parameter.

In stage S303 a feasibility response is generated and provided, wherein the feasibility response is an indicator for the effect caused by the at least one feasibility process parameter to the production process 202.

The method ends in stage S304. In one example the method may be implemented as a computer-implemented method and/or as a microservice.

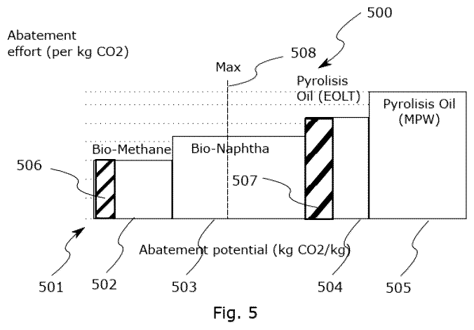

FIG. 4 shows a graphical user interface 400 for operating a revising apparatus according to an exemplary embodiment of the present invention.

The graphical user interface 400 has at least one product enter field 401 for receiving a product identifier. The graphical user interface may be displayed on local display device 205 and/or on a remote display.

In a target value column 402, a target value for the environmental impact parameter for the production process of the product may be provided and/or entered, e.g. a target PCF value.

The measure column 403 is used to enter and/or display a quantity for at least one measure for influencing the environmental impact parameter for the production process for producing the product. In order to save space only a subset of measures may be shown. The quantity may be a portion value of a share of a replacement product to an original product.

Dependent on an entry in target value column 402 and/or the measure column 403 a decision is made which feasibility process parameter 402, 403 is to be provided.

If a target value for the environmental impact parameter, e.g. a PCF value, is entered in the target value column 402, then a quantity 403, e.g. a percentage value, for at least one measure for influencing the environmental impact parameter for the production process for producing the product is delivered in the row “proposed”.

However, if a quantity 403 for at least one measure and/or a mix of measures for influencing the environmental impact parameter for the production process for producing the product is provided in measure column 403 in the row “proposed”, a target value for the environmental impact parameter for the production process of the product is delivered.

In an alternative embodiment, a target value for the environmental impact parameter may be entered in the target value column 402 and a minimum quantity for at least one measure for influencing the environmental impact parameter for the production process for producing the product may be provided in the measure column 403. In this case a solution is provided that aims at satisfying both goals.

Any assessment of an effort for a measure is displayed in effort column 404.

Proposal row 405 is used to make any suggestions if a target value for the environmental impact parameter may not be reached. This row 405 also indicates if a target may not be reached. In this row an alternative target value for the environmental impact parameter may be shown and a measure and/or a mix of measure in order to achieve the alternative target.

With this information a user may find an appropriate mix of measure in order to reach a target value.

In this way for example a CO2 abatement may be determined. The revising apparatus 201 may be used for different achievements with regard to CO2 abatement.

The revising apparatus 201 may help to determine the minimal effort and/or cost increase to achieve a CO2 target. The effort may be higher because special feedstock, such as renewable and/or recycled feedstock may be used as input.

Another approach may be, finding the CO2 reduction resulting from a specific mix of measures. In this way the amendment of feedstock and the impact of such amendments to the target value for the environmental impact parameter for the production process of the product may be examined.

A further examination may be made by finding the measure and/or mix of measures for which the effort and/or costs is/are low but still an impact to the target value, e.g. a CO2 value, may be realized.

In this way a balance and/or tradeoff between target value, measures and/or efforts be made.

Thus, in an example a sustainability target of a product, e.g. maximum PCF with minimum recycled or renewable content, may be provided as input. In another example a minimum PCF with minimum recycled or renewable content may be provided as input. In yet another example a maximum difference for a target may be provided.

In another example maximum sustainability units, e.g. heating value equivalents or balancing units or scope 2 electricity may be provided that can be substituted in the product and/or in the production process for producing the product.

For each sustainable raw material candidate and/or green electricity a PCF reduction per sustainability unit, effort/cost per sustainability unit, and/or further requirements may be set, e.g., vegan, etc.

The revising apparatus 201, may provide for each sustainable raw material candidate and/or green electricity combination a chosen quantity per kg product, a replaced amount in terms of sustainability units/kWh electricity, a resulting PCF reduction, a resulting effort or cost increase in comparison to fossil raw material.

By applying this method, for individual products, a minimum cost increase to achieve a given PCF, renewable/recycled content target or any combination thereof may be examined. Furthermore, a minimum achievable PCF and resulting cost increase may be shown. As an additional option a maximum achievable renewable/recycled content target and resulting cost increase may be analyzed.

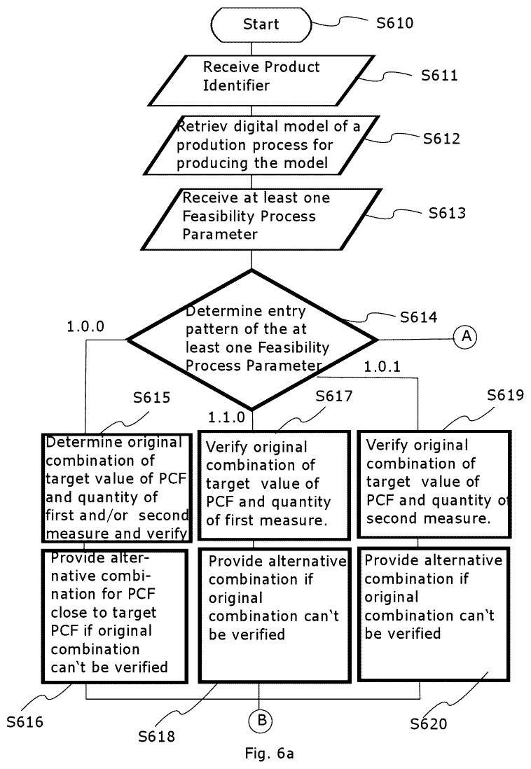

FIG. 5 shows a measure mix impact to a target value according to an exemplary embodiment of the present invention.

The graphical diagram 500 transparently shows the abatement effort on the ordinate versus the abatement potential on the abscissa. The diagram shows the potential of a mix of measures, such as renewable electricity 501 (not visible in the diagram), bio-methane 502, bio-naphtha 503, pyrolysis oil of end of time tiers (EOLT) 504 and pyrolysis oil of mixed plastic waste (MPW) 505.

Portions 506 and 507 of bio-methane 502 and pyrolysis oil of end of time tiers (EOLT) 504 show a share of replaced feedstock. Line 508 shows the maximum achievable reduction in the environmental impact parameter.

This graphical representation of the actual mix may help finding further mixes in order to reach a predefined objective according to an adaptation of a target value for the environmental impact parameter for the production process of the product.

The method may use an optimization algorithm where a minimum or maximum with respect to a specific objective, e.g., the required effort, is to be found over a predefined set of measures. The measures comprise a union of renewable and recycling content which are assumed to replace Naphtha and/or natural gas. Lower bounds are defined for renewable and recycling content, and upper bounds are defined with regard to the target value, e.g. a PCF value. The lower bounds and upper bounds are the sustainability targets and/or the target value for the environmental impact parameter for the production process of the product.

Different sources for green energy are also included in the optimization model. The green energy may replace energy generated from fossil sources. The energy may be received from different countries and generated in different ways.

Infeasibility breakers and penalties are used in the optimization model for not meeting the desired target values. The corresponding costs and/or effort for employing a set of measures are considered in the optimization model as one example of a potential objective function.

It is therefore an objective of the optimization model to minimize the cost/effort increase caused by a measure and/or mix of measures while meeting the sustainability targets, e.g. while meeting a target value for the environmental impact parameter for the production process of the product.

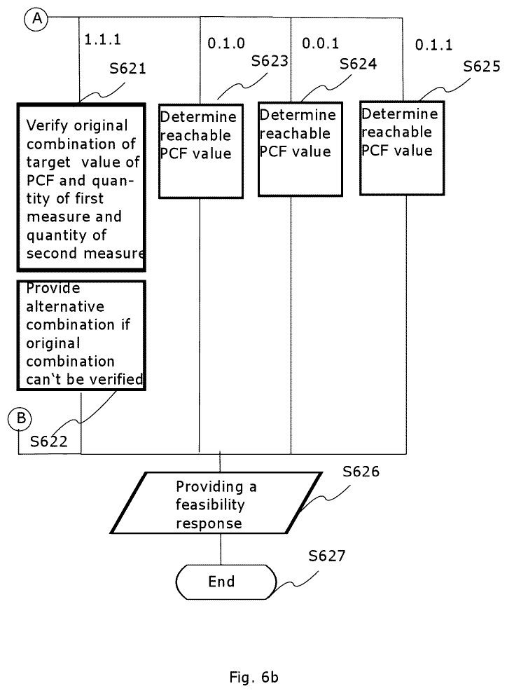

FIG. 6a,b show a more detailed view of the flow chart of FIG. 3 for a method for revising and/or generating an environmental impact parameter of a production process for producing a product according to an exemplary embodiment of the present invention.

Without limiting the scope of the disclosure, in the description of FIGS. 6a, 6b it is assumed that the environmental impact parameter is a PCF value. It is however recalled that instead of a PCF value any environmental sustainability value may be used. In other examples the environmental impact parameter may be a sustainability attribute such as any greenhouse gas emission and/or water pollution.

The method starts in stage S610. In stage S611 the method may comprise receiving a product identifier for identifying the product and/or the production process. The product identifier may be entered via graphical user interface 400. For example, the product identifier is entered in the product enter field 401 of user interface 400.

In an alternative example the product identifier may be received via an API.

The product identifier as entered in stage S611 is used to retrieve in stage S612 data of a production process for producing and/or generating a product, a digital model and/or a digital twin of the production process 202. Such a digital model of the production process 202 may form the basis for an analysis and/or for an assessment of the production process for producing the product and in particular for assessing the product. The digital model may be retrieved from data base 206

In stage S613 at least one feasibility process parameter is received. The feasibility process parameter may comprise at least one of a target value for the environmental impact parameter for the production process for producing the product and a quantity for at least one measure for influencing the environmental impact parameter for the production process for producing the product.

The at least one feasibility process parameter may be entered in the user interface 400 in target value column 402 and/or in one of the at least one measure columns 403, 403a, 403b. Dependent on the position and/or column in the user interface 400 on which position the information of the feasibility process parameter may be entered into the user interface 400 the type of entered information may be detected. The entered information may also determine which output is to be provided by the method.

In other words, the method derives from the feasibility process parameter a feasibility pattern and/or a feasibility process pattern.

The method may decide in stage S614 how to continue. In an example the decision may be based on the feasibility pattern.

In case of using an API for entering the at least one feasibility process parameter the parameter may be provided under a name in a received data package. An example for a data package may be a JSON (JavaScript Object Notation) file with a corresponding element. A feasibility pattern may be derived in substantially the same way as when received via graphical user interface 400.

In other words, in stage S614 an entry pattern and/or feasibility pattern of the at least one feasibility process parameter may be provided. The entry pattern may be formed according to the type of information of the feasibility process parameter and/or by the combination of the types of feasibility process parameter. That means that the variation of types of feasibility process parameter may be converted to a code for the selected mode of assessing the production process. The type of feasibility process parameter may be parsed.

In one example the feasibility process parameter may be a combination of a target value for a PCF value 402 for the production process for producing the product, a quantity of recycled feedstock as a first measure 403a for influencing the PCF value for the production process for producing the product and a quantity of renewable feedstock as a second measure 403b for influencing the PCF value for the production process for producing the product.

Table 1 shows an example of what a coding by the type of feasibility process parameter may look like.

TABLE 1

| PCF 402 | Recycled Feedstock 403a | Renewable Feedstock 403b |
|---|---|---|
| 6 KG CO2/kg | 0% | 0% |
| 1 | 0 | 0 |

Table 1 may represent an extraction of the graphical user interface 400. At any position in the table where an input is provided the Boolean value “1” or “True” is set. At any position where no input and/or a zero input may be provided the Boolean value “0” or “False” is set. The combination of Table 1 may indicate that the target value for PCF is available, that the quantity for the first measure is not available and the quantity for the second measure is also not available. This information written in the binary format may correspond to a feasibility pattern of 1.0.0.

In other words, the method may derive from the input format of the at least one feasibility process parameter the basis for assessing the production process.

If in stage S614 only a target value for the PCF value 402 for the production process for producing the product is recognized the feasibility pattern corresponds to 1.0.0. In this case in stage S615 an original combination of the quantity of the first measure 403a and/or the quantity of the second measure 403b is determined for meeting the desired target PCF value 402. This combination may include the target value for the PCF value 402 with the quantity of the first measure 403a only or the target value for the PCF value 403a with the quantity of the second measure 403b only.

If the desired and/or original target PCF value 402 cannot be determined, reached, or verified, in stage S616 an alternative combination may be determined that is as close as possible to the desired target PCF value 402.

This solution and/or combination that can be verified may be stored in a feasibility response variable.

Should the desired target PCF value 402 not be generatable with any combination of the quantities for the first and/or second measure 403a, 403b the feasibility response variable may be set for indicating that no solution is available.

If in stage S614 a target value for the PCF value 402 for the production process for producing the product and a quantity for the first measure 403a is recognized, the feasibility pattern may correspond to 1.1.0. In this case in stage S617 a verification is made whether the selected quantity for the first measure 403a can meet the desired target PCF value. The combination of the selected quantity for the first measure 403a and the desired target PCF value may form an original combination. For this assessment the production process is assessed on the basis of the at least one feasibility process parameter.

If the desired and/or original target PCF value 402 cannot be reached and the original combination can't be verified, in stage S618 an alternative combination is determined. Such alternative combination may comprise different amounts for the target value of the PCF 402 and for the quantity for the first measure 403a. In an alternative example a valid combination of the target value of the PCF and the quantity for the first measure 403a and/or the quantity for the second measure 403b may be provided in stage S618. I.e. more than the recognized measures are provided. In other words, even if the feasibility pattern asks for the combination of a target PCF value and a single measure, the generated result comprises an additional measure 403b.

This solution and/or combination that can be verified may be stored in the feasibility response variable.

Should the desired target PCF value 402 not be generatable with any combination of the target PCF value and the quantities for the first 403a and/or second measure 403b, a corresponding feasibility response variable may be set for indicating that no solution is available.

If in stage S614 a target value for the PCF value 402 for the production process for producing the product and a quantity for the second measure 403b is recognized, the feasibility pattern may correspond to 1.0.1. In this case in stage S619 a verification is made whether the selected quantity for the second measure 403b can meet the desired target PCF value. The combination of the selected quantity for the second measure 403b and the desired target PCF value may form an original combination. For this assessment the production process is assessed on the basis of the at least one feasibility process parameter.

If the desired and/or original target PCF value 402 cannot be reached and the original combination can't be verified, in stage S620 an alternative combination is determined. Such alternative combination may comprise different amounts for the target value of the PCF 402 and of the quantity for the second measure 403b. In an alternative example a valid combination of the target value of the PCF and the quantity for the second measure 403b and/or the quantity for the first measure 403a may be provided in stage S620. I.e. more than the recognized measures are provided. In other words, even if the feasibility pattern asks for the combination of a target PCF value and a single measure, the generated result comprises an additional measure 403a.

This solution and/or combination that can be verified may be stored in a feasibility response variable.

Should the desired target PCF value 402 not be generatable with any combination of the target PCF value and the quantities for the first and/or second measure 403a, 403b, the corresponding feasibility response variable may be set for indicating that no solution is available.

If in stage S614 a target value for the PCF value 402 for the production process for producing the product, a quantity for the first measure 403a and a quantity for the second measure 403b are recognized as input in the graphical user interface 400, the feasibility pattern may correspond to 1.1.1. In this case in stage S621 a verification is made whether the selected quantity for the first measure 403a and the second measure 403b can meet the desired target PCF value. The combination of the target value for the PCF value 402, the quantity for the first measure 403a and the quantity for the second measure 403b may form an original combination. For this assessment the production process is assessed on the basis of the at least one feasibility process parameter.

If the desired and/or original target PCF value 402 cannot be reached and the original combination can't be verified, in stage S622 an alternative combination is determined. Such alternative combination may comprise different amounts of the target value of the PCF 402, of the quantity of the first measure 403a and of the quantity for the second measure 403b.

This solution and/or combination that can be verified may be stored in the feasibility response variable.

Should the desired target PCF value 402 not be generatable with any combination of the target PCF value and the quantities for the first and/or second measure 403a, 403b, the feasibility response variable may be set for indicating that no solution is available

If in stage S614 no target value for the PCF value 402 for the production process for producing the product, but a quantity for the first measure 403a is recognized and no quantity for the second measure 403b is recognized, the feasibility pattern may correspond to 0.1.0. In this case in stage S623 the method may determine which PCF value 402 may be reachable with the selected quantity for first measure 403a. For this assessment the production process is assessed on the basis of the at least one feasibility process parameter.

The PCF value 402 that is possible with this first measure 403a may be stored in the feasibility response variable.

In an alternative example different quantities for the second measure 403b may be examined and a check is made whether a better, e.g. smaller, target value of the PCF can be reached by combining the first measure 403a with a second measure 403b. If so, the quantity for the first measure 403a and/or the quantity for the second measure 403b and the target value of the PCF may be stored as an alternative combination in the feasibility response variable.

If in stage S614 no target value for the PCF value 402 for the production process for producing the product, but a quantity for the second measure 403b is recognized and no quantity for the first measure 403a is recognized, the feasibility pattern may correspond to 0.0.1. In this case in stage S624 the method may determine which PCF value 402 can be reached with the selected quantity for second measure 403b. For this assessment the production process is assessed on the basis of the at least one feasibility process parameter.

The PCF value 402 that is possible with this second measure 403b may be stored in the feasibility response variable.

In an alternative example different quantities for the first measure 403a may be examined and a check is made whether a better, e.g. smaller, target value of the PCF can be reached by combining the second measure 403b with a first measure 403a. If so, the quantity for the first measure 403a and/or the quantity for the second measure 403b and the target value of the PCF may be stored as an alternative combination in the feasibility response variable.

If in stage S614 no target value for the PCF value 402 for the production process for producing the product, but a quantity for the first measure 403a and a quantity for the second measure 403b is recognized, the feasibility pattern may correspond to 0.1.1. In this case in stage S625 the method may determine which PCF value 402 can be reached with the selected mix of quantities for the first measure 403a and for the second measure 403b. For this assessment the production process is assessed on the basis of the at least one feasibility process parameter.

The PCF value 402 that is possible with the first measure 403a and the second measure 403b may be stored in the feasibility response variable.

In an alternative example different quantities for the first measure 403a and the second measure 403b may be examined and a check is made whether a combination with a better, e.g. smaller, target value of the PCF can be reached. If so, the quantity for the first measure 403a and the quantity for the second measure 403b and the target value of the PCF may be stored as an alternative combination in the feasibility response variable.

In stage S626 a feasibility response in form of the feasibility response variable is displayed. The variable may be displayed on the user interface 400 in proposal row 405. The display may show the results of the determining and/or verifying stages S615, S617, S619, S621, S623, S624, S625.

The feasibility variable may be an indicator for the effect caused by the at least one feasibility process parameter to the production process. In other words, the feasibility response may indicate whether a specific PCF value can be reached by a predetermined and/or suggested measure or mix of measure. The feasibility variable may be also an indicator for what PCF value may be reachable by a specific measure or mix of measure. In this way it may be possible to amend a PCF value 402 and in particular to lower the PCF value 402. A review and/or optimization of an existing production process may be possible.

In another example the effort for amending and/or reducing a PCF value 402 may be provided.

In an example a new product number may be generated for the product with the reduced PCF values. In another example the product number is left unchanged compared to the product identifier used in stage S611 and an additional attribute for indicating the PCF value may be added, e.g. a “low PCF” attribute.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE NUMERALS

101.1 . . . 101.n plurality of peripheral computing nodes of a centralized computing environment
101.1′ . . . 101.n′ plurality of computing nodes of a decentralized computing environment
101 example of one of the plurality of peripheral computing nodes
101 example of one of the plurality of computing nodes
102, 102′ hardware processor
104, 104′ memory
106, 106′ plurality of structures of program code
108, 108′ communication channels
110, 110′ user interface system
110A, 110A′ output mechanisms
110B, 110B′ input mechanisms
112 central computing node
101.1′ to 101.n′ plurality of computing nodes of decentralized computing environment
100′ decentralized computing environment
101 computing node
103 distributed cloud computing environment
114 mobile device(s),
116 applications,
118 databases,
120 data storage and
122 server(s)
124 public cloud,
126 private cloud
128 hybrid cloud.
201 revising apparatus
202 production process
203 user interface
204 processing device
205 local display device
206 database
S300 . . . . S304 stages of the method for revising an environmental impact parameter
400 user interface
401 product enter field
402 target value column
403 measure column
403a first measure
403b second measure
404 effort column
405 proposal row
500 diagram
501 renewable electricity (502
502 bio-methane
503 bio-naphtha,
504 pyrolysis oil of end of time tiers (EOLT)
505 pyrolysis oil of material plastic waste (MPW)
506 portion of bio-Methane
507 portion of pyrolysis oil (EOLT)
508 maximum line
S610 . . . . S627 stages of the method for revising an environmental impact parameter

1. A method for revising an environmental impact parameter of a production process for producing a product, the method comprising:
receiving a product identifier for identifying the product and/or the production process for producing the product;
receiving at least one feasibility process parameter;
wherein the at least one feasibility process parameter comprises at least one of
a target value for the environmental impact parameter for the production process for producing the product; and/or
a quantity for at least one measure for influencing the environmental impact parameter for the production process for producing the product;
assessing the production process on the basis of the at least one feasibility process parameter; and
providing a feasibility response;
wherein the feasibility response is an indicator for the effect caused by the at least one feasibility process parameter to the production process.

2. The method of claim 1, wherein the feasibility response comprises a quantity of at least one measure and/or a mix of measures for reaching the target value for the environmental impact parameter for the production process of the product.

3. The method of claim 1, wherein the feasibility response comprises an effort value for reaching the target value for the environmental impact parameter for the production process of the product.

4. The method of claim 1, further comprising:
ranking the at least one measure for influencing the environmental impact parameter in order to show a preference for one of the at least one measure for influencing the environmental impact parameter for the production process for producing the product.

5. The method of claim 1, wherein the at least one measure for influencing the environmental impact parameter depends on the received product identifier.

6. The method of claim 1, wherein assessing the production process on the basis of the at least one feasibility process parameter deploys an environmental attribute calculation schema.

7. The method of claim 1, wherein assessing the production process on the basis of the at least one feasibility process parameter deploys an optimization model.

8. The method of claim 1, wherein the environmental impact parameter for the production process of a product is selected from the group of:
a product carbon footprint value;
a wastewater value;
an emission value;
a heating value; and
a waste incineration value.

9. The method of claim 1, wherein the at least one measure for influencing the environmental impact parameter is a measure selected from the group consisting of:
employing sustainable material;
employing green energy;
employing a circular feedstock;
employing a renewable feedstock;
employing a recycled feedstock;
employing end of life tires;
employing mixed waste plastic;
employing bio-naphtha; and
employing bio-methane.

10. The method of claim 1, wherein parameters for the production process are substantially derived from a database.

11. The method of claim 1, further comprising:
controlling the production process of a product in a plant and/or in a production network with the quantity for the at least one measure for influencing the environmental impact parameter for the production process of the product for.

12. A computer program element with instructions, which when executed on a processing device are configured to carry out the method of claim 1.

13. A smart contract with instructions, which when executed on a processing device are configured to carry out the method of claim 1.

14. An apparatus for revising an environmental impact parameter of a production process for producing a product, the apparatus comprising:
a user interface for receiving a product identifier for identifying the product and/or the production process for producing the product; and for receiving at least one feasibility process parameter;
wherein the at least one feasibility process parameter comprises at least one of
a target value for the environmental impact parameter for the production process of the product; and/or
a quantity for at least one measure for influencing the environmental impact
parameter for the production process of the product;
a processing device for assessing the production process on the basis of the at least one feasibility process parameter;
wherein the user interface is configured for providing a feasibility response;
wherein the feasibility response is an indicator for the effect caused by the at least one feasibility process parameter to the production process.

15. The revising apparatus of claim 14, wherein the user interface comprises an API.

16. The method of claim 6, wherein the environmental attribute calculation schema is a mass balance calculation schema.
